(19) United States
(12) Patent Application Publication
(10) Pub. No.: US 2002/0158612 A1
(43) Pub. Date: Oct. 31, 2002

(54) VERY LOW QUIESCENT CURRENT REGULATOR AND METHOD OF USING

(75) Inventors: Pierre Andre Genest, Rouffiac Tolosan (FR); Joel Turchi, Toulouse (FR)

Correspondence Address: Robert D. Atkins, ON Semiconductor, Patent Administration Dept - MD A230, P.O. Box 62890, Phoenix, AZ, 85082-2890, US

(73) Assignee: Semiconductor Components Industries, LLC

(21) Appl. No.: 09/842,962

(22) Filed: Apr. 27, 2001

(51) Int. Cl. G05F 1/40

(52) U.S. Cl. 323/274

(57) ABSTRACT

Voltage regulator (10) provides current sense comparator (18) to detect the normal and standby modes of operation for voltage regulator (10). During a normal mode of operation, current sense comparator (18) de-asserts signal (MODE), causing voltage regulator (10) to regulate the output voltage to a predetermined level. Once the current (Iᵢₙ) has diminished below a predetermined value, current sense comparator (18) asserts signal (MODE) to indicate a standby mode. During the standby mode, regulator (10) regulates the output voltage (Vₒᵤₜ) between first and second reference levels, requiring a quiescent current level much less than the quiescent current level required during normal mode, due to the deactivation of current sense comparator (18) and error amplifier (28) during standby mode. An alternate method of quiescent current reduction uses switched voltage reference (86). Bandgap reference (80) supplies voltage reference (V_{ref1}) during normal mode of operation and depletion MOS reference supplies voltage reference (V_{ref1}) during standby mode of operation.

### BACKGROUND OF THE INVENTION

The present invention relates in general to voltage regulators and, more particularly, to voltage regulators requiring very little quiescent current in a standby mode of operation.

Electronic devices such as Global System for Mobile Communications (GSM) cellular telephones and laptop computers generally require operational power in two separate modes of operation. A first mode of operation is provided such that the regulator is supplied enough quiescent current to allow sufficient noise immunity, Power Supply Rejection Ratio (PSRR) and dynamic performance, for example, requiring maximum quiescent current. A second mode of operation is characterized as a standby mode of operation, where the regulator supplies a coarsely regulated potential without the high performance specification requirements of the first mode. A fraction of the quiescent current, therefore, is needed in standby mode, to maintain only critical components required to detect a transition from standby mode into the fully operational mode at the desired time. The provisioning of two separate modes of operation, allows the electronic device to conserve energy during the standby mode of operation.

Prior art voltage regulators provide four main components. First, an error amplifier that generates an error voltage between the actual output voltage and the desired output voltage. Second, an internal voltage reference that generates a reference voltage, typically with a bandgap reference, which is used by the error amplifier to generate the error voltage. Third, a pass transistor, typically p-type, used to operate in linear mode, controlling the amount of current delivered to the load. Fourth, a buffer used to buffer the control input of the pass transistor from the output of the error amplifier.

Prior art voltage regulators employ error amplifiers designed to exhibit proper performance during nominal, or full function, operation. Full function operation of the prior art error amplifier requires enough quiescent current such that the error amplifier, for example, provides proper noise immunity while providing the specified dynamic performance. Typical quiescent current required by prior art regulators is approximately 30 micro-amps(uA) during full function operation. Prior art regulators, however, do not employ dual mode operation, whereby an idle or standby mode is detected with a subsequent reduction in power consumption during the idle or standby mode.

Hence, there is a need for a voltage regulator providing the ability to detect the standby operational mode and further implementing a reduction in power consumption while operating in the standby mode.

### BRIEF DESCRIPTION OF THE DRAWINGS

FIG. 1 is a schematic diagram illustrating a voltage regulator operational in standby and full function modes;

FIG. 1A is a schematic of switchable reference voltages optionally used by the voltage regulator of FIG. 1;

FIG. 2 is a waveform plot useful in explaining the operation of the voltage regulator of FIG. 1; and

FIG. 3 is a block diagram of a timing circuit optionally used by the voltage regulator of FIG. 1.

### DETAILED DESCRIPTION OF THE DRAWINGS

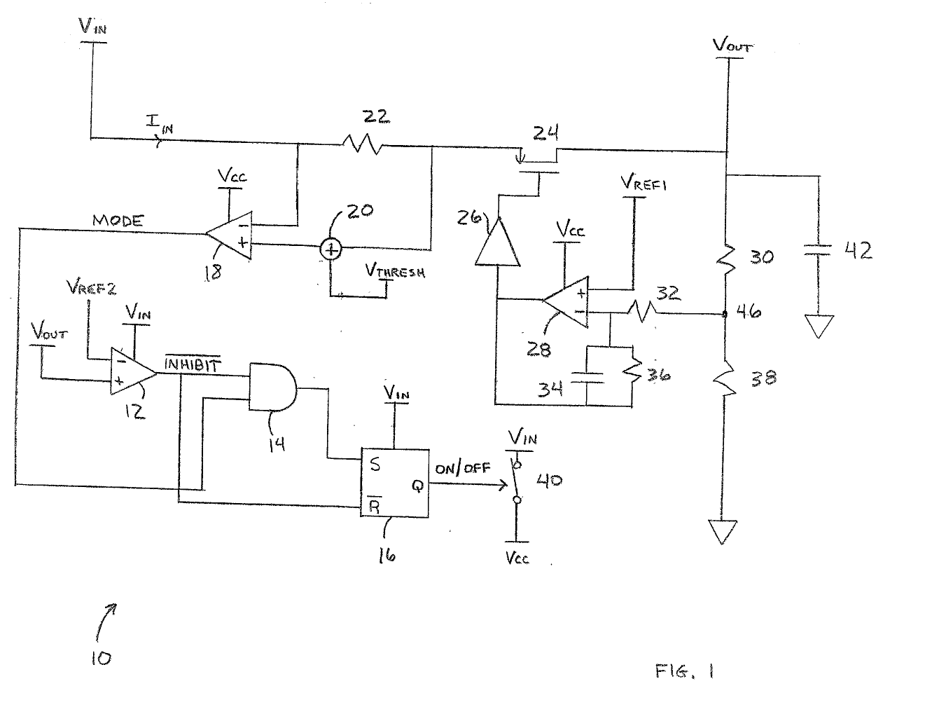

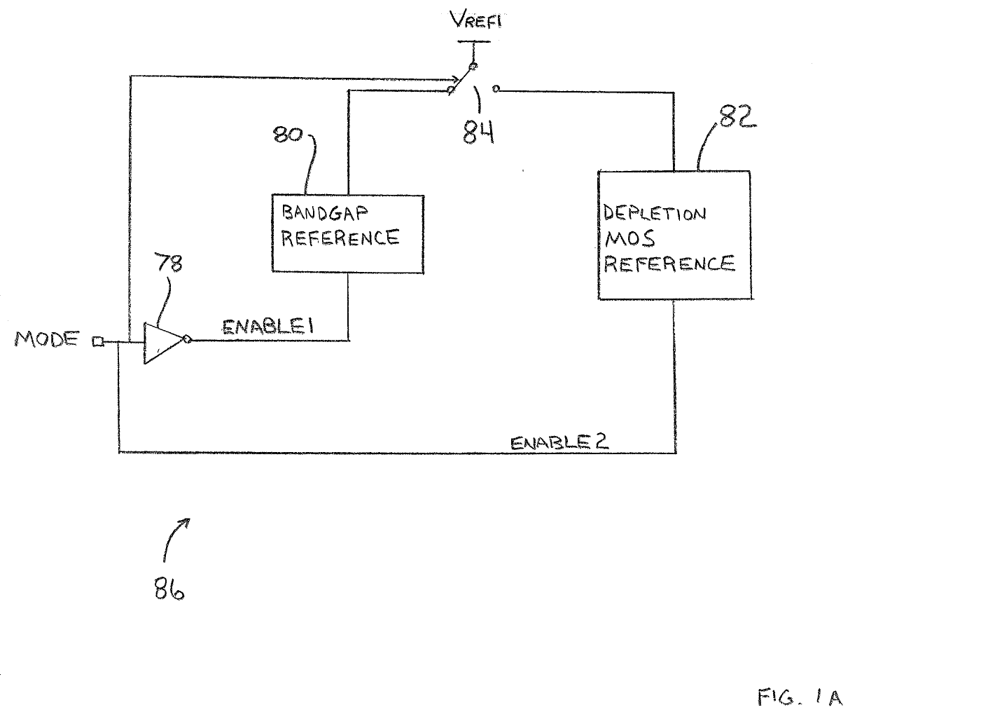

In FIG. 1, a schematic diagram of voltage regulator 10 is illustrated. A current path exists between node Vᵢₙ and node Vₒᵤₜ through resistor 22 and pass transistor 24, used to deliver supply current to a load connected to node Vₒᵤₜ (not shown). Pass transistor 24 is typically a p-type device. A first conductor of resistor 30 is coupled to a first conductor of transistor 24, terminal Vₒᵤₜ, and a first terminal of capacitor 42. A second conductor of capacitor 42 is coupled to a second supply potential, for example, ground potential. A second conductor of resistor 30 is coupled to a first conductor of resistor 38 and a first conductor of resistor 32 at node 46. A second conductor of resistor 38 is coupled to a second power supply, for example, ground potential. The inverting input of error amplifier 28 is coupled to a second conductor of resistor 32. The non-inverting input to error amplifier 28 is coupled to voltage reference V_{ref1}. Error amplifier 28 derives operational supply voltage from terminal V_{cc}. The output of error amplifier 28 is coupled to a first conductor of resistor 36, a first conductor of capacitor 34 and to the input to buffer 26. Second conductors of resistor 36 and capacitor 34 are coupled to the inverting input of error amplifier 28. The output of buffer 26 is coupled to the control terminal of pass transistor 24. The inverting input of comparator 18 is coupled to node Vᵢₙ and to a first conductor of resistor 22. It should be noted that although a direct connection from the inverting input of comparator 18 to the Vᵢₙ terminal is illustrated in FIG. 1, only a portion of Vᵢₙ, perhaps through a voltage divider (not shown) for example, is taken at the inverting input to comparator 18. An equivalent voltage divider (not shown) for the non-inverting input to comparator 18 is also used. A first conductor of summer 20 is coupled to a second conductor of resistor 22 and a first conductor of transistor 24. A second conductor of summer 20 is coupled to Vₜₕᵣₑₛₕ. The output terminal of summer 20 is coupled to the non-inverting input to current sense comparator 18. The output of current sense comparator 18 is coupled to a second input of AND gate 14. Current sense comparator 18 receives operating supply potential from terminal V_{cc}. Hysteretic comparator 12 receives Vₒᵤₜ and V_{ref2} at the non-inverting and inverting inputs of comparator 12, respectively. The output of comparator 12 is coupled to a first input of AND gate 14. Comparator 12 receives operating potential from terminal Vᵢₙ. The output of AND gate 14 is coupled to the set input of SR flip flop 16. The reset input of SR flip flop 16 is coupled to the output of comparator 12. The Q output of SR flip flop 16 provides signal ON/OFF to the control terminal of switch 40. Switch 40 is coupled to terminal Vᵢₙ at a first conductor and to terminal V_{cc} at a second conductor.

In operation, voltage regulator 10 controls pass transistor 24 to supply a current to a load connected to terminal Vₒᵤₜ (not shown) during a full function mode of operation. A full function mode of operation is defined to be the mode of operation where switch 40 is closed, thereby supplying operational power to comparator 18 and error amplifier 28 via the V_{cc} terminal. Full function mode may also include other auxiliary functions, such as over-current protection circuitry (not shown), which receives operational power from the V_{cc} terminal. Regulator 10 requires, for example, 100 micro-amps (uA) of quiescent current during full function mode of operation. A second mode of operation, or standby mode, is defined to be the mode of operation whereby switch 40 is open, thereby disabling comparator 18 and error amplifier 28, and other auxiliary components (not shown), by removing the operating supply potential V_{cc} from the respective operating supply potential inputs of comparator 18 and error amplifier 28 and other auxiliary components (not shown). Standby mode, therefore, provides operational power only to comparator 12, AND gate 14 and SR flip flop 16 through terminal Vᵢₙ. Standby mode quiescent current, for example, is approximately 1 uA. Standby mode is detected through the use of AND gate 14, SR flip flop 16 and current sense comparator 18 as discussed hereinafter.

Voltage regulator 10 is a linear mode voltage regulation circuit, regulating voltage at terminal Vₒᵤₜ to a potential lower than Vᵢₙ. Vᵢₙ, for example, ranges from 3 to 6 volts and Vₒᵤₜ is, for example, regulated between 1.8 to 2.8 volts. The conduction state of transistor 24 is controlled by the output of buffer 26. As the output voltage of buffer 26 reduces, transistor 24 increases conductivity, which allows an increased amount of current to flow into capacitor 42, increasing the magnitude of Vₒᵤₜ. As the magnitude of Vₒᵤₜ varies, the magnitude of the voltage at node 46 also varies according to the voltage divider ratio established by resistors 30 and 38. The voltage at node 46 is compared to the reference voltage V_{ref1} and the difference between the voltage at node 46 and V_{ref1} is amplified by error amplifier 28 according to the gain established by the ratio of resistor 36 to resistor 32 and the stability of the control loop is established by capacitor 34, which sets a first order pole in the transfer function of the voltage control loop. The voltage control loop being established by the divided output voltage feedback from node 46, through error amplifier 28, through buffer 26 and finally into the control terminal of transistor 24. Buffer 26 is an inverting buffer, such that increasing voltage at the input to buffer 26 results in decreasing voltage at the output of buffer 26. Conversely, decreasing voltage at the input to buffer 26 results in increasing voltage at the output of buffer 26.

Capacitor 42 receives charge current, Iᵢₙ, from terminal Vᵢₙ, via sense resistor 22 and pass transistor 24. Accordingly, the voltage present at terminal Vₒᵤₜ increases due to the accumulation of charge across capacitor 42. The voltage at node 46, V₄₆, varies in proportion to the voltage at terminal Vₒᵤₜ according to the following equation: V₄₆=Vₒᵤₜ*R₃₈/(R₃₈+R₃₀), where R₃₈ is the resistance of resistor 38 and R₃₀ is the resistance of resistor 30. Error amplifier 28 receives the proportionally increased voltage, V₄₆, at the inverting input and compares the proportionally increased voltage to the reference voltage, V_{ref1}, present at the non-inverting input. If the voltage at the inverting input of error amplifier 28 is greater than V_{ref1}, error amplifier 28 compensates by decreasing the output voltage of error amplifier 28. The decreasing output voltage of error amplifier 28 is buffered and inverted by buffer 26, such that the voltage at the control terminal of transistor 24 increases. Since transistor 24 is p-type, the conductivity of transistor 24 reduces, decreasing the amount of current supplied to capacitor 42, thereby reducing Vₒᵤₜ. If, on the other hand, the voltage at the inverting input of error amplifier 28 is less than V_{ref1}, indicating a falling voltage at terminal Vₒᵤₜ, error amplifier 28 compensates by increasing the output voltage of error amplifier 28. The increasing output voltage of error amplifier 28 is buffered and inverted by buffer 26, such that the voltage at the control terminal of transistor 24 decreases. Since transistor 24 is p-type, the conductivity of transistor 24 increases, increasing the amount of current supplied to capacitor 42, thereby increasing Vₒᵤₜ. It can be seen, therefore, that the voltage control loop serves to linearly regulate the voltage at terminal Vₒᵤₜ to a voltage substantially equal to

Vₒᵤₜ=V_{ref1}(1+R₃₀/R₃₈) (1)

during a normal mode of operation.

Sense resistor 22, in combination with current sense comparator 18 and summer 20, provide a current sensing function for regulator 10. As current Iᵢₙ flows through sense resistor 22, a potential develops across resistor 22. Current sense comparator 18 performs a voltage subtraction of voltages present at the inputs to current sense comparator 18. The voltage present at the inverting input, Vᵢₙᵥ, of current sense comparator 18 is given by Vᵢₙᵥ=Vᵢₙ. The voltage present at the non-inverting input, Vₙₒₙ₋ᵢₙᵥ, of current sense comparator 18 is given by Vₙₒₙ₋ᵢₙᵥ=Vᵢₙ−V₂₂+Vₜₕᵣₑₛₕ, where V₂₂ is the voltage developed across sense resistor 22 by current Iᵢₙ. Subtracting Vᵢₙᵥ from Vₙₒₙ₋ᵢₙᵥ, to produce V_{diff}, V_{diff}=Vₙₒₙ₋ᵢₙᵥ−Vᵢₙᵥ=Vₜₕᵣₑₛₕ−V₂₂.It can be seen, therefore, that if V_{diff} is positive, Vₜₕᵣₑₛₕ is larger than V₂₂, indicating that Iᵢₙ is below the full function current threshold, Iₜₕᵣₑₛₕ. When Iᵢₙ is below the full function threshold, Iₜₕᵣₑₛₕ, signal MODE asserts to a logic high indicating standby mode. Conversely, if V_{diff} is negative, V₂₂ is larger than Vₜₕᵣₑₛₕ, indicating that Iᵢₙ is above the full function current threshold, Iₜₕᵣₑₛₕ. When Iᵢₙ is above the full function current threshold, Iₜₕᵣₑₛₕ, signal MODE de-asserts to a logic low indicating normal mode. It should be noted that other current sense circuits, such as current mirrors, can be used as an alternate current detection means. In addition, normal and standby modes may also be detected by using the output voltage of error amplifier 28. The output voltage of error amplifier 28 is monitored by a second comparator (not shown). If the error voltage is below a predetermined threshold, for example, the second comparator's output indicates that the current drive of regulator 10 is low and, therefore, standby mode is indicated. Conversely, if the error voltage is above the predetermined threshold, for example, the second comparator's output indicates that the current drive of regulator 10 is high and, therefore, normal mode is indicated.

AND gate 14 and hysteretic comparator 12 combine to form a gating circuit for signal MODE. A logic high output from comparator 12 serves to allow AND gate 14 to pass the MODE signal to the set input of SR flip flop 16 and a logic low output from comparator 12 serves to block the MODE signal from the set input of SR flip flop 16. Comparator 12 is a hysteretic comparator such that the comparator output triggers at different applied voltage levels depending upon the slope of the voltage applied at the input to comparator 12. A positive sloped voltage for Vₒᵤₜ at the non-inverting input to comparator 12, for example, causes a logic high output when Vₒᵤₜ exceeds a first voltage threshold level, Vₜₕᵣₑₛₕ₁, which is above V_{ref2}. Conversely, a negative sloped voltage for Vₒᵤₜ causes a logic low output when Vₒᵤₜ is less than a second threshold level, Vₜₕᵣₑₛₕ₂, which is below V_{ref2}. The magnitude of Vₜₕᵣₑₛₕ₂ being less than the magnitude of Vₜₕᵣₑₛₕ₁. SR flip flop 16 receives the output of AND gate 14 at the S input and asserts signal ON/OFF to a logic high level when the S input transitions from a logic low to a logic high level. The R input of SR flip flop 16 receives the output of comparator 12 and causes the Q output to reset to a logic low level, de-asserting signal ON/OFF, when the output of comparator 12 transitions from a logic high level to a logic low level. Switch 40 operates in response to the ON/OFF signal. Switch 40 is open, disconnecting Vᵢₙ from V_{cc}, when signal ON/OFF is at a logic high level and switch 40 is closed, connecting Vᵢₙ to V_{cc}, when signal ON/OFF is at a logic low level. Error amplifier 28 and current sense comparator 18 are shown to be inhibited during a non-charging phase of the standby mode by removing the supply potential, Vᵢₙ, from the V_{cc} terminal, through the operation of a voltage control circuit comprising hysteretic comparator 12, AND gate 14 SR flip flop 16 and switch 40. It should be noted that SR flip flop 16 is reset dominant, such that the simultaneous occurrence of the set and reset signals results in the reset of SR flip flop 16. Alternate methods may be used to disable functional blocks during the standby mode. Systems utilizing internal current sources to provide operational power to functional blocks, for example, are inhibited by controlling the internal current sources using signal ON/OFF, as opposed to, enabling and disabling the V_{cc} supply voltage using signal ON/OFF, as discussed above.

An alternate method of reducing quiescent current during a standby mode of operation is implemented through the use of switched voltage reference 86, as shown in FIG. 1A. Signal MODE is received by inverter 78, the control terminal of switch 84 and the ENABLE2 terminal of depletion Metal Oxide Semiconductor (MOS) reference 82. The output voltage of bandgap reference 80 and depletion MOS reference 82 is supplied to first and second conductors of switch 84, respectively. Under normal operating conditions, signal MODE is at a logic low level. Bandgap reference 80 is enabled, since signal ENABLE1 is at a logic high level due to the operation of inverter 78. The position of switch 84 is as shown in FIG. 1A, such that bandgap reference 80 supplies potential V_{ref1} during the normal mode of operation. Under standby mode of operation, during a non-charging phase of regulator 10, signal MODE is at a logic high level, setting signal ENABLE2 to a logic high level. Since ENABLE2 is at a logic high level, depletion MOS reference 82 is enabled and switch 84 is selecting the output of depletion MOS reference 82 to supply V_{ref1}. Selecting between two reference generation circuits as shown in FIG. 1A, results in a quiescent current reduction during standby mode of, for example, a factor of 25. In other words, normal mode operation results in a quiescent current drain of 100 uA, for example, using bandgap reference 80 and a 4 uA drain, for example, using depletion MOS reference 82. It should be noted that use of switched references as shown in FIG. 1A, allows error amplifier 28 and hysteretic comparator 18 to remain connected to Vᵢₙ during standby mode. In other words, all components of voltage regulator 10 remain active while in standby mode and the quiescent current reduction is obtained entirely through the use of voltage reference 86. It should be noted that implementation of switched voltage reference 86 precludes the use of hysteretic comparator 12, AND gate 12, SR flip flop 16 and switch 40, which are components required to disconnect V_{cc} from terminal Vᵢₙ. Implementation of switched voltage reference 86, in other words, allows regulator 10 to function at a reduced quiescent current while allowing all components of regulator 10 to be operative, through the use of a low power voltage reference, such as depletion MOS reference 82.

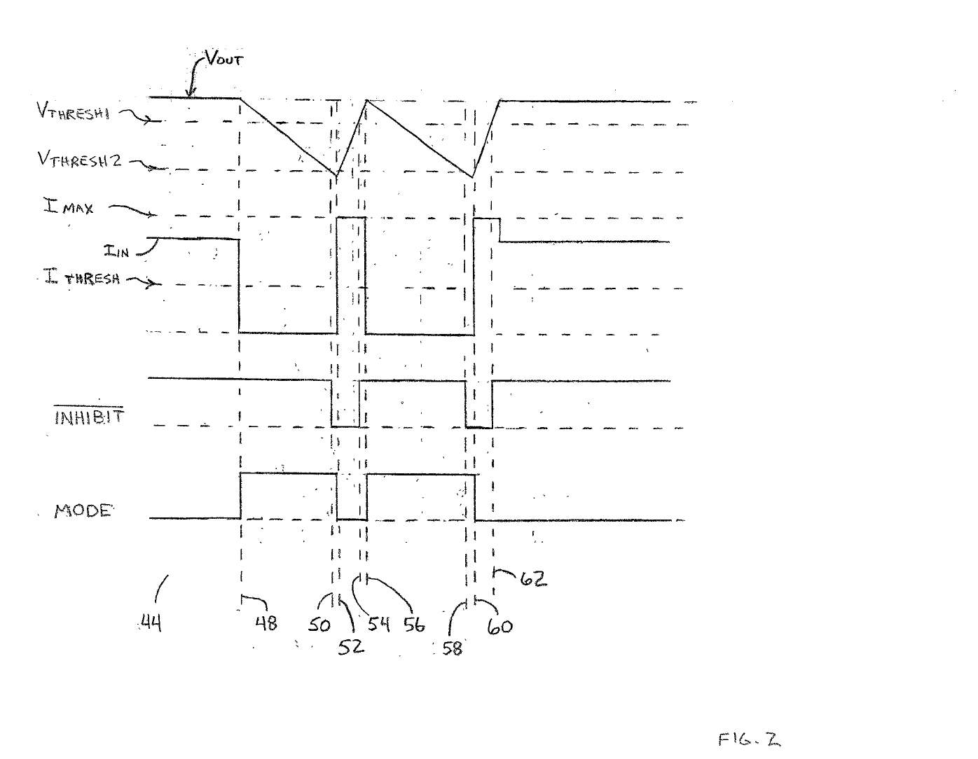

FIG. 2 displays a waveform plot illustrating the operation of voltage regulator 10. At time 44, voltage regulator 10 is in full function, or normal mode. Vₒᵤₜ is fully regulated according to equation (1) and Iᵢₙ is at a level above Iₜₕᵣₑₛₕ.At time 48, Iᵢₙ decreases as the load connected to terminal Vₒᵤₜ (not shown) is diminished. Once Iᵢₙ passes through Iₜₕᵣₑₛₕ, the voltage across sense resistor 22 reduces below Vₜₕᵣₑₛₕ, causing signal MODE to assert to a logic high. Since Vₒᵤₜ exceeds Vₜₕᵣₑₛₕ₁ at time 48, signal \overline{INHIBIT} is at a logic high and the output of AND gate 14 sets SR flip flop 16. Setting SR flip flop 16 causes signal ON/OFF to assert to a logic high, disabling switch 40. Once disabled, switch 40 disconnects Vᵢₙ from terminal V_{cc}, causing current sense comparator 18 and error amplifier 28 to turn off. Regulator 10, therefore, enters into a standby mode of operation beginning at time 48. Error amplifier 28 is non-functional, since terminal V_{cc} is disconnected from terminal Vᵢₙ. Pass transistor 24 is no longer conductive, allowing the voltage across capacitor 42 to diminish, due to the action of the load connected to terminal Vₒᵤₜ (not shown) discharging capacitor 42. Vₒᵤₜ diminishes to a voltage equal to Vₜₕᵣₑₛₕ₂ at time 50, triggering hysteretic comparator 12 to assert signal \overline{INHIBIT} to a logic low value. The logic high to logic low transition of signal \overline{INHIBIT} at the R input of SR flip flop 16 causes the ON/OFF signal to reset to a logic low, enabling switch 40 to the closed position, coupling terminal Vᵢₙ to terminal V_{cc}. Time 52, therefore, marks the beginning of a charging phase, within the standby mode, whereby voltage regulator 10 engages pass transistor 24 to supply current to capacitor 42. As current Iᵢₙ increases above Iₜₕᵣₑₛₕ to Iₘₐₓ, shortly after time 52, signal MODE transitions to a logic low value. At time 54, Vₒᵤₜ has increased to the value of Vₜₕᵣₑₛₕ₁, which causes signal \overline{INHIBIT} to transition from a logic low to a logic high value. Voltage Vₒᵤₜ continues to increase, since error amplifier 28 is driving the output voltage Vₒᵤₜ to be substantially according to equation (1). Once output voltage Vₒᵤₜ reaches the regulated value defined by equation (1), current Iᵢₙ decreases and transitions signal MODE from a logic low to a logic high after current Iᵢₙ decreases below Iₜₕᵣₑₛₕ, at time 56. Since signal \overline{INHIBIT} is at a logic high value, the transition of signal MODE at time 56 causes AND gate 14 to provide a logic low to a logic high transition to the S input of SR flip flop 16. The Q output of SR flip flop 16 transitions from a logic low to a logic high value causing signal ON/OFF to transition to a logic high value, disabling switch 40, thereby decoupling terminal Vᵢₙ from terminal V_{cc}, which ends the charging cycle within the standby mode. Beginning at time 60, for example, the load coupled to terminal V_{cc} (not shown) increases to full load, causing Iᵢₙ to increase. Signal MODE de-asserts to a logic low value at time 60, followed by a logic low to logic high transition of signal \overline{INHIBIT}, at time 62, once Vₒᵤₜ exceeds Vₜₕᵣₑₛₕ₁. Normal voltage regulation resumes and full function, or normal operation, begins once again. It can be seen therefore, that regulator 10 provides a dual function voltage regulator. At normal loading conditions, regulator 10 employs full function voltage regulation, requiring, for example, 100 uA of quiescent current for operation. At below normal loading conditions, regulator 10 employs a reduced function voltage regulation, requiring, for example, 1 uA of quiescent current for operation.

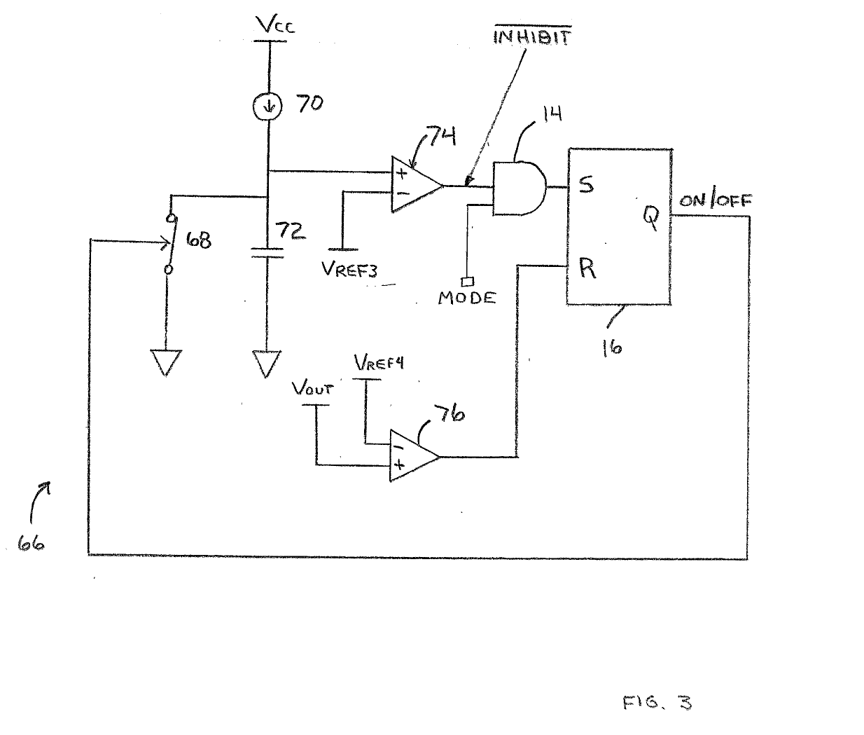

FIG. 3 illustrates a timing circuit 66, employed to set a predetermined charge time, T_{charge}, while in the standby mode. A first conductor of switch 68 is coupled to the non-inverting input of comparator 74, a first conductor of current source 70 and a first conductor of capacitor 72. Second conductors of switch 68 and capacitor 72 are coupled to a second supply potential, for example, ground potential. A first conductor of current source 70 is coupled to terminal V_{cc}. The inverting input to comparator 74 is coupled to reference V_{ref3}. The output of comparator 74 is coupled to provide signal \overline{INHIBIT} to a first input of AND gate 14. A second input of AND gate 14 is coupled to receive signal MODE. The non-inverting input to comparator 76 is coupled to terminal Vₒᵤₜ and the inverting input to comparator 76 is coupled to V_{ref4}. The output of comparator 76 is coupled to the reset input, R, of SR flip flop 16. The Q output of flip flop 16 establishes signal ON/OFF, which controls switch 68.

In operation, timer circuit 66 provides a predetermined charge time, T_{charge}, which is used by regulator 10 to determine the length of time that the charging phase is active during the standby mode of operation. The charging phase during a standby mode, for example, is shown in FIG. 2 to be between times 52 and 56. Signal ON/OFF is at a logic high during a non-charging phase of the standby mode. The amount of time, T_{charge}, between time 52 and time 56 is determined by timing circuit 66. At time 44, signal ON/OFF is at a logic low level, denoting normal mode. Switch 68 is disabled, allowing capacitor 72 to charge, due to the current from current source 70. The output of comparator 76 is at a logic high level, since Vₒᵤₜ exceeds V_{ref4}. Once the voltage across capacitor 72 exceeds V_{ref3}, the output of comparator 74 de-asserts signal \overline{INHIBIT} to a logic high level. At time 48, signal MODE is asserted to a logic high level by current sense comparator 18. The output of AND gate 14 asserts to a logic high level, which sets SR flip flop 16. The Q output of SR flip flop 16 asserts signal ON/OFF to a logic high level, which activates switch 68, shorting capacitor 72 to ground potential. Since the non-inverting input of comparator 74 is at ground potential, signal \overline{INHIBIT} is asserted to a logic low level. The voltage at terminal Vₒᵤₜ falls below V_{ref4}, which causes the output of comparator 76 to transition from a logic high to a logic low level, resetting SR flip flop 16 and de-asserting signal ON/OFF to a logic low level. De-asserting signal ON/OFF to a logic low level activates the charging phase of regulator 10 during the standby mode. Signal ON/OFF opens switch 68, allowing a voltage to develop across capacitor 72 according to the current supplied by current source 70. Meanwhile, current Iᵢₙ increases above current Iₜₕᵣₑₛₕ, which asserts signal MODE. Once an amount of time, T_{charge}, transpires, the voltage across capacitor 72 exceeds V_{ref3}, causing the output of comparator 74 to transition to a logic high level, de-asserting signal \overline{INHIBIT} to a logic high level and setting SR flip flop 16, since signal MODE is asserted high. The ON/OFF signal is then asserted to a logic high level, which ends the charging phase. It can be seen, therefore, that timing circuit 66 implements another method to control the amount of charge time required by regulator 10 during a charging phase of standby mode. Controlling the charge time during standby mode performs a reduced function voltage regulation, allowing coarse voltage regulation during standby mode at substantially reduced quiescent current levels. In general, a timer circuit can also be implemented which measures an amount of time between the beginning of the standby mode and the start of a charging phase as shown at times 48 and 52, respectively, obviating the need for comparator 76.

In summary, a voltage regulator is presented, which allows detection of a standby mode, indicating low current operation. Once the standby mode is detected, a low quiescent current mode is established for the regulator, which diminishes the amount of quiescent current required by the regulator by approximately two orders of magnitude, for example. During the standby mode, the regulator establishes charging cycles to maintain the output voltage at a coarsely regulated potential. Once the standby mode is terminated, normal regulation resumes and the voltage regulator provides voltage regulation to a finely regulated potential.

What is claimed is:

1. A voltage regulator operational in first and second modes reducing power consumption during the second mode, the voltage regulator comprising:
a regulation circuit having an input coupled to an output node and coupled to provide a drive control signal in response to a feedback signal in the first mode;
a detection circuit having an input coupled to the output node and coupled to provide a control signal indicative of the second mode; and
a voltage control circuit having an input coupled to the output node and coupled to receive the control signal and coupled to disable the regulation circuit and the detection circuit in response to the control signal.

2. The voltage regulator of claim 1, wherein the regulation circuit comprises an error amplifier having a first input coupled to the output node, a second input coupled to receive a reference signal and an output coupled to provide the drive control signal.

3. The voltage regulator of claim 1, wherein the detection circuit comprises a current sense amplifier having a first input coupled to receive a threshold signal, a second input coupled to the output node and an output coupled to provide the control signal.

4. The voltage regulator of claim 1, wherein the voltage control circuit comprises:
a comparator having a first input coupled to the output node, a second input coupled to receive a reference signal and an output coupled to provide a gating signal; and
a memory storage device coupled to receive the gating signal and having an output coupled to provide a switch control signal.

5. The voltage regulator of claim 4, wherein the memory storage device includes an RS flip flop.

6. The voltage regulator of claim 4, wherein the voltage control circuit further comprises:
a logic circuit having a first input coupled to receive the gating signal and a second input coupled to receive the control signal; and
a switch having a control input coupled to receive the switch control signal and coupled to disable the regulation circuit and the detection circuit.

7. The voltage regulator of claim 6, wherein the logic circuit includes an AND gate.

8. A multi-mode regulator operating in normal and standby modes to regulate an output signal, comprising:
a regulator operative in the standby mode to regulate between first and second output levels, the regulator comprising,
(a) a detector coupled to receive a drive signal indicative of an output drive level and coupled to provide a deactivation signal when the drive signal is above a predetermined threshold, and
(b) an activation circuit coupled to receive the deactivation signal and coupled to deactivate a first supply potential after the output signal reaches the second output level.

9. The multi-mode regulator of claim 8, wherein the detector comprises:
a summer coupled to receive the drive signal and a reference level indicative of the predetermined threshold; and
a current sense amplifier having a first input coupled to receive the input signal and a second input coupled to receive an output of the summer.

10. The multi-mode regulator of claim 8, wherein the activation circuit comprises a hysteretic comparator coupled to receive the output signal and coupled to deactivate the first supply potential after the output signal reaches the second output level.

11. The multi-mode regulator of claim 8, wherein the activation circuit comprises a timer circuit coupled to receive the output signal and coupled to provide a timer signal, wherein the timer signal deactivates the first supply potential.

12. The multi-mode regulator of claim 11, wherein the timer circuit comprises:
a capacitor having a first conductor coupled to provide the timer signal at a first node and a second conductor coupled to a second supply potential; and
a switch having a first conductor coupled to the first node and a second conductor coupled to the second supply potential, wherein the switch operates to reset the timer signal.

13. A method of producing a regulated output from a multi-mode regulator, comprising:
operating a first regulation control circuit in a normal mode of operation;
detecting a decreased output level of the multi-mode regulator;
disabling the first regulation control circuit upon detection of the decreased output level; and
operating a second regulation control circuit in a reduced power consumption mode.

14. the method of claim 13, wherein detecting the decreased output level comprises:
generating a signal indicative of the output level; and
comparing the signal to a predetermined threshold.

15. The method of claim 13, wherein disabling the first regulation control circuit comprises disconnecting a supply potential from the first regulation control circuit.

16. The method of claim 13, wherein operating the second regulation control circuit in the reduced power consumption mode comprises:
monitoring an output level of the multi-mode regulator;
engaging the first regulation control circuit when the regulated output reaches a first predetermined threshold; and
disengaging the first regulation control circuit when the regulated output reaches a second predetermined threshold.

17. A method of operating a voltage regulator to provide a first regulated signal during a first output drive level and a second regulated signal during a second output drive level, the method comprising:
providing a feedback signal indicative of the first regulated signal during the first output drive level;
regulating the first regulated signal to substantially equal a first reference level;
detecting the second output drive level; and regulating the second regulated signal substantially between the first reference level and a second reference level.

18. The method of claim 17, wherein detecting the second output drive level comprises:
generating a signal indicative of the output drive level; and
comparing the signal to a predetermined threshold.

19. The method of claim 17, wherein regulating the second regulated signal comprises:
monitoring the second regulated signal;
engaging a charging circuit when the second regulated signal reaches the second reference level; and
disengaging the charging circuit when the second regulated signal reaches the first reference level.

20. The method of claim 17, wherein regulating the second regulated signal comprises:
monitoring the second regulated signal;
engaging a charging circuit when the second regulated signal reaches the second reference level;
engaging a timer circuit; and
disengaging the charging circuit when a timing signal from the timer circuit becomes active.

21. A method of reducing power consumption of a voltage regulator during a standby mode of operation comprising:
detecting the standby mode of operation; and
selecting a reduced power consumption device upon detection of the standby mode of operation.

22. The method of claim 21 wherein selecting a reduced power consumption device comprises:
monitoring a signal indicative of the standby mode of operation; and
enabling the reduced power consumption device using the signal indicative of the standby mode.
